(19) United States
(12) Patent Application Publication
(10) Pub. No.: US 2013/0057809 A1
(43) Pub. Date: Mar. 7, 2013

(54) OPTICALLY-COMPENSATORY SHEET, POLARIZING PLATE AND LIQUID CRYSTAL DISPLAY DEVICE

(71) Applicants: Shun Nakamura, Minami-Ashigara-shi (JP); Hideyuki Nishikawa, Kanagawa (JP); Hisato Nagase, Minami-Ashigara-shi (JP); Ayako Muramatsu, Minami-Ashigara-shi (JP); Taketo Otani, Minami-Ashigara-shi (JP)

(72) Inventors: Shun Nakamura, Minami-Ashigara-shi (JP); Hideyuki Nishikawa, Kanagawa (JP); Hisato Nagase, Minami-Ashigara-shi (JP); Ayako Muramatsu, Minami-Ashigara-shi (JP); Taketo Otani, Minami-Ashigara-shi (JP)

(21) Appl. No.: 13/601,221

(22) Filed: Aug. 31, 2012

(30) Foreign Application Priority Data
Sep. 2, 2011 (JP) 2011-192075

(51) Int. Cl. G02F 1/1335; B32B 9/04; G02B 5/30

(52) U.S. Cl. 349/96; 349/117; 359/489.07; 428/704

(57) ABSTRACT

There is provided an optically-compensatory sheet including, at least one optically anisotropic layer containing a discotic liquid crystalline compound on a transparent support, wherein the optically anisotropic layer contains a boronic acid compound represented by the following Formula (I):

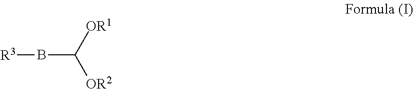

wherein, each of R¹ and R² independently represents a hydrogen atom, a substituted or unsubstituted aliphatic hydrocarbon group, an aryl group or a hetero cyclic group, and R¹ and R² may be linked to each other to form a ring, and R³ represents a substituted or unsubstituted, a substituted or unsubstituted aliphatic hydrocarbon group, a substituted or unsubstituted aryl group or a substituted or unsubstituted heterocyclic group.

### CROSS-REFERENCE TO RELATED APPLICATION(S)

The present application claims priority from Japanese Patent Application No. 2011-192075 filed on Sep. 2, 2011, the entire content of which is incorporated herein by reference.

### BACKGROUND

1. Field

The present invention relates to an optically-compensatory sheet, which is applied to a liquid crystal display device, and a polarizing plate and a liquid crystal display device using the optically-compensatory sheet.

2. Description of the Related Art

Liquid crystal display device (LCD) includes a liquid crystal cell and a pair of polarizing plates sandwiching the cell. Generally, the polarizing plate includes a protective film made from cellulose acetate and a polarization film, and is prepared by, for example, dying the polarization film made from a polyvinyl alcohol film with iodine and stretching the film, followed by laminating both faces thereof with the protective film.

For the purpose of compensating distortion of images seen from various viewing angles, resulted from phase difference of polarized light passed through the liquid crystal cell, one or more phase difference films may be disposed adjacent to the protective film. This phase difference film is also called an optically-compensatory sheet, and may be used as the protective film of the polarizing plate by directly adhering to the polarization film.

Recently, each panel maker is improving display character of the liquid crystal display device more and more because of high user demand for in-plane contrast, viewing angle contrast, change of color sense and the like, and rapid improvement. Among them, the in-plane contrast is an important item of display grade, and therefore it is needed to further improve the in-plane contrast.

The in-plane contrast of the liquid crystal display device may be properly improved by enhancing the alignment of liquid crystal molecules in the liquid crystal cell or inhibiting a scattering component of a color filter. Further, in the case of a liquid crystal display device applied with an optically-compensatory sheet having an optically anisotropic layer (also called a liquid crystal layer), wherein liquid crystals are aligned and fixed, it is known that the alignment of the fixed liquid crystal affects to the in-plane contrast.

For example, in the case of the optically-compensatory sheet as described in Japanese Patent Laid-Open No. 2010-231198, obtained by using a cellulose acetate film as a support (optionally installed with the alignment film), coating discotic liquid crystals thereon and fixing the aligned liquid crystals, it is known that if the alignment direction of the liquid crystals to be fixed is not uniform, the contrast becomes worse.

There are many methods to make the alignment direction of the liquid crystals uniform, and in Japanese Patent Laid-Open No. 2010-231198, oblique evaporation, light alignment and magnetic alignment are proposed. However, the above-described methods are not industrially realistic in perspectives of yield/mass-production.

Further, it has been generally known that if liquid crystal director angle near the alignment film becomes lower, azimuth angle anchoring force of the liquid crystals becomes strong, and thereby, the alignment direction becomes uniform. This method is certainly effective on improving the in-plane contrast, but a controlling agent or the alignment film is needed to decrease the liquid crystal director angle near the alignment film of the discotic liquid crystalline compound. For example, additives and the like increasing the liquid crystal director angle are disclosed in Japanese Patent Laid-Open No. 2006-113500 and the like. However, in the case of using the additives, there was a problem of bad adhesion between the alignment film and the liquid crystal layer. Further, the adhesion from the alignment film side may be enhanced by introducing a polymerizable group to the alignment film and the like. However, in this case, the polymerizable group deteriorates the alignment of the liquid crystals and the like. That is, improving the liquid crystal director and achieving uniform alignment by securing adherence of the alignment film and the liquid crystal layer have not been realized yet.

The present invention has been made in consideration of all the problems. Therefore, an object of the present invention is to provide an optically-compensatory sheet, with a simple configuration, improving in-plane contrast when applied to a liquid crystal display device due to secured close adhesion and uniform alignment of an optically anisotropic layer having high liquid crystal director. Another object of the present invention is to provide a polarizing plate and a liquid crystal display device using the optically-compensatory sheet.

The present inventors have conducted intensively studies, and as a result, the above-mentioned objects are achieved by the following means.

(1) An optically-compensatory sheet having, at least one optically anisotropic layer containing a discotic liquid crystalline compound on a transparent support, wherein the optically anisotropic layer contains a boronic acid compound represented by the following Formula (I):

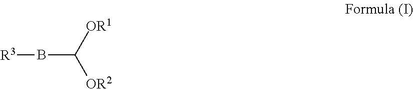

wherein, each of R¹ and R² independently represents a hydrogen atom, a substituted or unsubstituted aliphatic hydrocarbon group, an aryl group or a hetero cyclic group, and R¹ and R² may be linked to each other to form a ring, and R³ represents a substituted or unsubstituted, a substituted or unsubstituted aliphatic hydrocarbon group, a substituted or unsubstituted aryl group or a substituted or unsubstituted heterocyclic group.

(2) The optically-compensatory sheet according to (1), further having, an alignment film provided between the transparent support and the optically anisotropic layer, wherein the alignment film is a polyvinyl alcohol.

(3) The optically-compensatory sheet according (1), wherein a liquid crystal director angle of the discotic liquid crystalline compound at a support side is 0° or more and less than 40°.

(4) The optically-compensatory sheet according to (1), wherein a film contrast value represented by the following Equation (1) is 4,000 or more:

Film contrast value=(Maximum luminance of an optically-compensatory sheet arranged on two polarizing plates of parallel nicols state)/(Minimum luminance of an optically-compensatory sheet arranged on two polarizing plates of cross nicols state). Equation (1)

(5) The optically-compensatory sheet according to (1), wherein the discotic liquid crystalline compound has an inverse hybrid alignment.

(6) The optically-compensatory sheet according to (1), wherein a value from a crosscut adhesion test in accordance with JIS K5400-8.5 (JIS D0202) is 1 point or more.

(7) A polarizing plate having an optically-compensatory sheet according to (1).

(8) A liquid crystal display device having the optically-compensatory sheet of according to (1).

(9) A liquid crystal display device having the polarizing plate according to (7).

According to exemplary embodiments of the present invention, an optically-compensatory sheet, which can improve in-plane contrast of a liquid crystal display device and includes an optically anisotropic layer having good adherence and uniformly aligned liquid crystalline compounds; and a polarizing plate and a liquid crystal display device using the optically-compensatory sheet may be provided.

Exemplary embodiments of the present invention will be described in detail based on the following FIGURE, wherein:

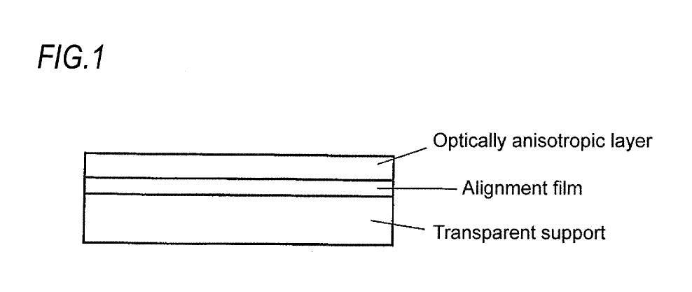

FIG. 1 is a schematic cross-sectional view illustrating an example of the optically-compensatory sheet of the present invention.

Hereinafter, the present invention will be described in detail.

In the description of the exemplary embodiments of the present invention, the term “parallel” or “orthogonal” means that an angle is within the range of the precise angle ±5°. Difference from the precise angles is preferably less than 4°, and more preferably less than 3°.

Further, regarding angle, the mark “+” means a clockwise direction, and the mark “−” means a counter-clockwise direction.

Further, the term “slow axis” means a direction showing the maximum refractive index, and unless otherwise specified, the refractive index is measured at a wavelength λ of 550 nm in the visible light region.

Further, in the description of the embodiments of the present invention, the term “polarizing plate” means a long polarizing plate or a piece obtained by cutting the plate into a size appropriate for the liquid crystal device unless otherwise specified. The term “cutting” means “punching”, “cutout” or the like. Further, in the description of the exemplary embodiments of the present invention, the terms “polarization film” and “polarizing plate” are distinguished from each other, and the “polarizing plate” is a laminate having a transparent protective film protecting the polarization film formed on at least one side of the “polarization film”.

Further, in the description of the embodiments of the present invention, the term “molecular symmetry axis” means a symmetry axis in a case where the molecule has a rotational symmetry axis, but in the strict sense of the word, the molecule is not required to be rotationally symmetric. Generally, in a discotic liquid crystalline compound, the molecular symmetry axis is coincided with the axis which penetrates the center of a disk face and is perpendicular to the disk, and in a rod-type liquid crystalline compound, the molecular symmetry axis is coincided with a longitudinal axis of the molecule.

In this specification, Re (λ) and Rth (λ) represent an in-plane retardation and retardation in a thickness-direction at wavelength λ, respectively. Re (λ) is measured by irradiating with an incident light of λ nm in wavelength in the normal direction of the film using KOBRA 21ADH or WR (manufactured by Oji Scientific Instruments Co., Ltd.). When selecting the wavelength of λ nm, the wavelength may be measured by manually exchanging a wavelength selective filter or converting the measured value by a program and the like. If the film to be measured is a mono-axial or bi-axial index ellipsoid, Rth (λ) is calculated by the following method. This method may also be used for measuring the average tilt angle on the alignment film side of the discotic liquid crystal molecule and the average tilt angle on the opposite side thereof in the optically anisotropic layer, which will be described later.

A total of six points of Re (λnm) are measured by irradiating with an incident light of λ nm in wavelength from each of the inclined directions at an angle increasing in 10° step increments up to 50° in one direction from the normal direction of the film by taking the in-plane slow axis (decided by KOBRA 21ADH or WR) as an inclined axis (axis of rotation) (when there is no slow axis, any in-plane direction of the film will be taken as an axis of rotation), and then Rth (λ nm) is calculated by KOBRA 21ADH or WR based on the retardation value measured, the average refractive index, and the film thickness value inputted. In the above description, in the case of a film having a direction in which a retardation value is zero at a certain tilt angle from the normal direction about the in-plane slow axis as an axis of rotation, a retardation value at a tilt angle greater than that certain tilt angle is changed into a minus sign, and then is calculated by KOBRA 21ADH or WR. Rth may also be calculated based on two retardation values measured in two different directions at any angle by taking the slow axis as an inclined axis (when there is no slow axis, any in-plane direction of the film will be taken as an axis of rotation), the average refractive index, and the film thickness inputted and from the following Equations (A) and (III).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {\{ nz cos ( {sin}^{- 1} ( \frac{sin ( - θ )}{nx} ) ) \}}^{2}\end{matrix}}} ] \times \frac{d}{cos ( {sin}^{- 1} ( \frac{sin ( - θ )}{nx} ) \}} \qquad Equation ( A )$$

The Re (θ) represents a retardation value in a direction inclined by an angle (θ) from the normal line direction. Further, in the Equation (A), the nx represents a refractive index in the in-plane slow axis direction; ny represents a refractive index in the in-plane direction orthogonal to the nx; nz represents a refractive index in the direction orthogonal to the nx and the ny; and d represents a thickness of the measured film.

Rth={(nx+ny)/2−nz}×d Equation (III)

When a film to be measured is not represented by a uniaxial or biaxial refractive index ellipsoid, so-called, when the film has no optic axis, Rth (λ) is calculated in the following manner. Eleven points of Re (λ) are measured by irradiating with an incident light of λ nm in wavelength from each of the inclined directions at an angle increasing in 10° step increments from −50° to +50° in one direction from the normal direction of the film by taking the in-plane slow axis (decided by KOBRA 21ADH or WR) as an inclined axis (axis of rotation), and then Rth (λ) is calculated by KOBRA 21ADH or WR based on the retardation value measured, the assumed value of the average refractive index, and the film thickness value inputted. In the above measurements, values described in a polymer handbook (John Wiley & Sons, Inc.) and catalogues of various optical films may be used as the assumed value of the average refractive index. For films whose average refractive index value is unknown, the value may be measured by using an Abbe's refractometer. Values of average refractive index of main optical films are illustrated below: Cellulose acylate (1.48), cycloolefin polymer (1.52), polycarbonate (1.59), polymethyl methacrylate (1.49) and polystyrene (1.59).

nx, ny and nz are calculated by inputting the assumed values of these average refractive index and the film thickness into KOBRA 21ADH or WR. Nz=(nx−nz)/(nx−ny) is further calculated from the thus calculated nx, ny and nz.

Meanwhile, the wavelength (λ) for measuring the refractive index is 550 nm in a visible light region, unless otherwise specified, and the wavelength (λ) for measuring the Re and Rth is 550 nm, unless otherwise specified.

(Measurement of Tilt Angle)

In the optically anisotropic layer where the discotic liquid crystalline compounds are aligned, it is difficult to accurately and directly measure a tilt angle at one face of the optically anisotropic layer (an angle between the physical object axis in the discotic liquid crystal compound and the interface of the optically anisotropic layer) (θ1), and a tilt angle at the other face of the optically anisotropic layer (θ2). Therefore, in this specification, the θ1 and the θ2 are calculated as follows. This method could not accurately express the actual alignment state, but may be useful as a means for indicating the relative relationship of some optional characteristics of the optical film.

In this method, the following two points are assumed for facilitating the calculation, and the tilt angles at two interfaces of the optically anisotropic layer are determined.

1. It is assumed that the optically anisotropic layer is a multi-layered structure including a layer containing the discotic liquid crystalline compounds. It is further assumed that the minimum unit layer constituting the structure (on the assumption that the tilt angle of the discotic liquid crystalline compounds is uniform inside the layer) is an optically mono-axial layer.

2. It is assumed that the tilt angle in each layer varies monotonously as a linear function in the thickness direction of the optically anisotropic layer.

A concrete method for calculation is as follows:

(1) The retardation is measured at three or more angles by varying the incident angle of light to be applied to the optically anisotropic layer, in a plane in which the tilt angle in each layer monotonously varies as a linear function in the thickness direction of the optically anisotropic layer. For simplifying the measurement and the calculation, it is preferred that the retardation is measured at three angles of −40°, 0° and +40° relative to the normal line direction to the optically anisotropic layer of being at an angle of 0°. The measurement may be conducted by using KOBRA-21ADH and KOBRA-WR (manufactured by Oji Scientific Instruments), transmission ellipsometer AEP-100 (manufactured by Shimadzu Corporation), M150 and M520 (manufactured by JASCO Corporation) and ABR10A (manufactured by Uniopt Corporation, Ltd.).

(2) In the above model, the refractive index of each layer for normal light is represented by no, the refractive index thereof for abnormal light is by ne (ne is the same in all layers, as well as no), and the overall thickness of the multi-layer structure is represented by d. On the assumption that the tilting direction in each layer and the mono-axial optic axis direction of the layer are the same, the tilt angle (θ1) in one face of the optically anisotropic layer and the tilt angle (θ2) in the other face thereof are fitted as variables such that the calculated data of the angle dependence of the retardation value of the optically anisotropic layer coincides with the measured data thereof, thereby calculating θ1 and θ2.

Herein, no and ne may be used as known values in literatures and catalogues. If the values are unknown, the values may be measured by using an Abbe's refractometer. The thickness of the optically anisotropic layer may be measured with an optical interference film thickness meter, on a photograph showing the cross-section of the layer taken by a scanning electron microscope and the like.

In this specification, the term “tilt angle” means an “average tilt angle” calculated by the said method.

<<Optically-Compensatory Sheet>>

The present invention relates to an optically-compensatory sheet including an optically anisotropic layer on a transparent support. The optically-compensatory sheet of the present invention is a layer wherein the optically anisotropic layer is formed from the discotic liquid crystalline compounds. Preferably, in a composition containing the discotic liquid crystalline compounds, the layer is formed by aligning the discotic liquid crystalline compounds followed by fixing thereof. In the present invention, the optically anisotropic layer contains at least one boronic acid compound.

Further, as shown in FIG. 1, an alignment film controlling the discotic liquid crystalline compounds may be formed on the transparent support, and the optically anisotropic layer may be formed on the alignment film.

<Discotic Liquid Crystalline Compound>

The discotic liquid crystalline compound, which is used in the exemplary embodiments of the present invention, may be a triphenylene compound, and a tri-substituted benzene which is substituted at 1-, 3- and 5-positions of the benzene, and preferably, for example, the following tri-substituted benzene having a structure of the following Formula (X) as a disc-shaped core.

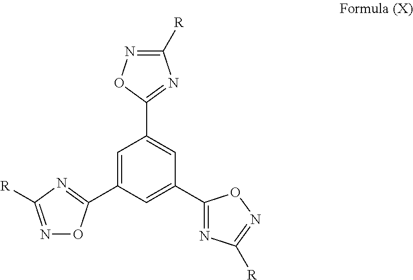

In Formula (X), each of R represents an organic substituent required to show liquid crystallinity of the compound of General Formula (X), and the R has the same meaning as the R¹, R² and R³ of Formula (II), which will be described later.

Since the discotic liquid crystalline compounds represented by Formula (X) show high Δn (birefringence) and low wavelength dispersibility, the optical film having the optically anisotropic layer formed by fixing the molecular alignment of the compound is very useful as the optically-compensatory film of the liquid crystal display device. Among them, the optical film having the optically anisotropic layer formed by fixing the molecules of the discotic liquid crystalline compound of Formula (X) in “vertical alignment” or “reverse hybrid alignment” is particularly useful as the optically-compensatory film of the liquid crystal display device.

The compound of Formula (X) is described in detail in Japanese Patent Laid-Open Nos. 2002-90545 and 2006-276203, and Japanese Patent Application No. 2009-68293, and particular examples thereof are described as well.

The discotic liquid crystalline compound may preferably have a polymerizable group to be fixed by polymerization. For example, a structure may be considered, in which a polymerizable group as a substituent is bonded to the disc-shaped core of the discotic liquid crystalline compound. However, if the polymerizable group is directly linked to the disc-shaped core, it would be difficult to maintain the aligned state in the polymerization reaction. Therefore, the structure having a linker between the disc-shaped core and the polymerizable group is preferred. Namely, the discotic liquid crystalline compound having a polymerizable group is preferably a compound represented by the following Formula (II).

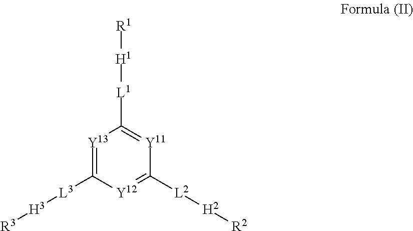

In Formula (II), each of Y¹¹, Y¹² and Y¹³ independently represents a substituted or unsubstituted methine or nitrogen atom; each of L¹, L² and L³ independently represents a monovalent linker or a divalent linker; each of H′, H² and H³ independently represents a group of Formula (I-A) or (I-B); and each of R′, R² and R³ independently represents the following Formula (I-R):

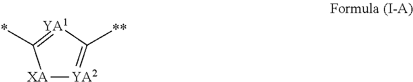

In Formula (I-A), each of YA¹ and YA² independently represents a methine or a nitrogen atom; XA represents an oxygen atom, a sulfur atom, a methylene or an imino; * represents a position bonded to the L¹ to L³ in Formula (II); and ** represents a position bonded to R¹ to R³ in Formula (II);

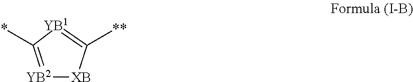

In Formula (I-B), each of YB¹ and YB² independently represents a methine or a nitrogen atom; XB represents an oxygen atom, a sulfur atom, a methylene or an imino; * represents a position bonded to the L¹ to L³ in Formula; and ** represents a position bonded to R¹ to R³ in Formula (II);

*-(-L²¹-Q²)ₙ₁-L²²-L²³-Q¹ Formula (I-R)

In Formula (I-R), * represents a position bonded to H¹ to H³ in Formula (II); L²¹ represents a monovalent linker or a divalent liner; Q² represents a divalent group having at least one cyclic structure (cyclic group); n1 represents an integer of 0 to 4; L²² represents **—O—, **—O—CO—, **—CO—O—, **—O—CO—O—, **—S—, **—NH—, **—SO₂—, **—CH₂—, **—CH═CH— or **—C≡C—; L²³ represents a divalent linker selected from a group consisting of —O—, —S—, —C (═O)—, —SO₂—, —NH—, —CH₂—, —CH═CH— and —C═C—, and a mixture thereof; and Q¹ represents a polymerizable group or a hydrogen atom.

The preferred ranges of the groups represented by each symbol in the tri-substituted benzene-based discotic liquid crystalline compound represented by Formula (II) and the specific examples of the compound of Formula (II) are described in the paragraphs [0013] to in Japanese Patent Laid-Open No. 2010-244038, [Chem. 13] to [Chem. 43] of the paragraph [0052] in Japanese Patent Laid-Open No. 2006-76992 and [Chem. 13] of the paragraph [0040] to [Chem. 36] of the paragraph [0063] in Japanese Patent Laid-Open No. 2007-2220. However, the discotic liquid crystalline compound, which can be used in the exemplary embodiments of the present invention, is not limited to the tri-substituted benzene-based discotic liquid crystalline compound of Formula (II).

Further, examples of the discotic liquid crystalline compound include a triphenylene compounds, and examples of the triphenylene compounds include the compounds as described in the paragraphs [0062] to [0067] in Japanese Patent Laid-Open No. 2007-108732 and the like, but the present invention is not limited thereto.

Examples of the discotic liquid crystalline compound include a di-substituted benzene compound which is substituted at 1- and 3-positions of the benzene, and examples of the di-substituted benzene compound include compounds as described in the paragraphs [0020] to [0064] in Japanese Patent application No. 2009-68293 and the like, but the present invention is not limited thereto.

In addition, examples of the discotic compound, which can be used in the present invention, include benzene derivatives (C. Destrade et al., Mol. Cryst., Vol. 71, p. 111 (1981)), truxene derivatives (C. Destrade et al., Mol. Cryst., Vol. 122, p. 141 (1985) and Physics lett, A, Vol. 78, p. 82 (1990)), cyclohexane derivatives (B. Kohne et al., Angew. Chem., Vol. 96, p. 70 (1984)) and azacrown-based or phenylacetylene-based macrocycles (J. M. Lehn et al., J. Chem. Commun, p. 1794 (1985) and J. Zhang et al., J. Am. Chem. Soc., Vol. 116, p. 2655 (1994)).

The alignment state of the liquid crystal molecules of the discotic liquid crystalline compound in the optically anisotropic layer is not particularly limited, but preferably, at least the interface of the support side (if the alignment film is formed, the interface of the formed alignment film) may achieve the tilted alignment state of high average tilt angle or the vertical alignment state. And the reverse hybrid alignment state, wherein the average tilt angle is decreased towards the air-interface direction by achieving the tilted alignment state of high average tilt angle or the vertical alignment state in the alignment film, is also preferred. Particularly, the state that the discotic liquid crystal molecule is at the tilted alignment state of high average tilt angle in the alignment film interface and at the reverse hybrid alignment state in which the tilt angle decreases towards the air-interface direction, is suitable for the optically-compensatory film of a TN-mode liquid crystal display device. When the discotic liquid crystal molecules are subjected to the vertical alignment or the reverse hybrid alignment, the discotic liquid crystal molecule may be aligned such that the disk face and the alignment film is parallel to the rubbing direction (hereinafter, also called “parallel alignment”), or may be aligned such that the normal line direction of the disk face is parallel to the rubbing direction (hereinafter, also called “orthogonal alignment”). The “parallel alignment” is predominant. Since the continuous production is used in the actual production, it is common for carrying out the rubbing treatment along the longitudinal direction of the film. Thus, considering bonding the long-type polarization film to the direction identical with the longitudinal direction, the “orthogonal alignment”, not the “parallel alignment”, is desired.

(Director Angle)

The molecules of the liquid crystalline compound forming the optically anisotropic layer of the present invention form a hybrid alignment, in which the angle formed by the director of the liquid crystalline compound molecules and the support face in the liquid crystal phase, changes depending on the distance between the support face and the molecule of the liquid crystalline compound. In this specification, the angle formed by the director of the liquid crystalline compound molecules and the support face means the angle formed by the direction vertical to the disk face of the discotic liquid crystalline compound and the support plane. In the case of the discotic liquid crystal, it is preferred that this angle is increased as the distance between the support plane and the liquid crystalline compound molecules is increased.

The measurement of the angle formed by the director of the liquid crystalline compound molecules and the support face may be performed by fitting to incidence angle dependence of the retardation as measured by rotating a sample using the slow axis as a rotation axis described in SID Symposium Digest vol. 34, page. 672 (2003), or polarization microscope observation of a thin sliced section. But in this specification, it is possible to perform the measurement by fitting to the incidence angle dependence of the retardation.

(Boronic Acid Compound)

For the optically anisotropic layer of the optically-compensatory sheet of the present invention, at least one boronic acid compound is used as a vertical alignment promoting agent at the support side interface (when the alignment film is formed, the interface of the formed alignment film). In the present invention, the boronic acid compound contributes to align the discotic liquid crystalline compound vertically to the interface of the alignment film.

Examples of the boronic acid compound, which can be used in the exemplary embodiments of the present invention, include a compound having at least one boronic acid group or boronic acid ester group, and may be a metal complex coordinated with them as ligands or a boronium ion having a tetra-coordinate boron atom at the same time.

The boronic acid compound, which can be used in the exemplary embodiments of the present invention, may be preferably represented by the following Formula (I), and hereinafter, the compound represented by Formula (I) will be described in detail.

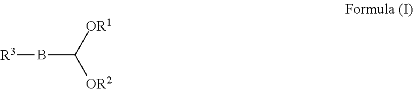

In Formula (I), each of R¹ and R² independently represents a hydrogen atom, a substituted or unsubstituted aliphatic hydrocarbon group, an aryl group or a heterocyclic group.

Examples of the aliphatic hydrocarbon group include a substituted or unsubstituted and linear or branched alkyl group having 1 to 20 carbon atoms (for example, a methyl group, an ethyl group, an isopropyl group and the like), a substituted or unsubstituted cyclic alkyl group having 3 to 20 carbon atoms (for example, a cyclohexyl group and the like), or an alkenyl group having 2 to 20 carbon atoms (for example, a vinyl group and the like).

Examples of the aryl group include a substituted or unsubstituted phenyl group having 6 to 20 carbon atoms (for example, a phenyl group, a tolyl group and the like), a substituted or unsubstituted naphthyl group having 10 to 20 carbon atoms, and the like.

Examples of the heterocyclic group include a substituted or unsubstituted 5-membered or 6-membered ring group having at least one heteroatom (for example, a nitrogen atom, an oxygen atom, a sulfur atom and the like), and specific examples thereof include a pyridyl group, an imidazolyl group, a furyl group, a piperidyl group, a morpholino group and the like.

R¹ and R² may be linked to each other to form a ring, and for example, isopropyl groups of R¹ and R² may be linked to form a 4,4,5,5-tetramethyl-1,3,2-dioxaborolane ring.

In Formula (I), preferably, R¹ and R² may be a hydrogen atom or a linear or branched alkyl group having 1 to 3 carbon atoms, and a case where R¹ and R² are linked to form a ring, and most preferably a hydrogen atom.

In Formula (I), R³ represents a substituted or unsubstituted aliphatic hydrocarbon group, aryl group or hetero cyclic group.

The aliphatic hydrocarbon group may be a substituted or unsubstituted linear or branched alkyl group having 1 to 30 carbon atoms (for example, a methyl group, an ethyl group, an isopropyl group, a n-propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, a sec-butyl group, a tert-butyl group, an isopentyl group, a neopentyl group, a 1-methylbutyl group, an isohexyl group, a 2-methylhexyl group and the like), a substituted or unsubstituted cyclic alkyl group having 3 to 20 carbon atoms (for example, a cyclopentyl group, a cyclohexyl group, an 1-adamantyl group, a 2-norbornyl group and the like), or a alkenyl group having 2 to 20 carbon atoms (for example, a vinyl group, a 1-prophenyl group, a 1-butenyl group, a 1-methyl-1-prophenyl group and the like).

Examples of the aryl group include a substituted or unsubstituted phenyl group having 6 to 50 carbon atoms (for example, a phenyl group, a tolyl group, a styryl group, a 4-benzoyloxyphenyl group, a 4-phenoxycarbonylphenyl group, a 4-biphenyl group, a 4-(4-octyloxybenzoyloxy)phenoxycarbonylphenyl group and the like), a substituted or unsubstituted naphthyl group having 10 to 50 carbon atoms (for example, an unsubstituted naphthyl group and the like), and the like.

Examples of the heterocyclic group include a substituted or unsubstituted 5-membered or 6-membered ring group having at least one heteroatom (for example, a nitrogen atom, an oxygen atom, a sulfur atom and the like), and for example, a group selected from a group consisting of a pyrrole, a furan, a thiophene, a pyrazole, an imidazole, a triazole, an oxazole, an isooxazole, an oxadiazole, a thiazole, a thiadiazole, an indole, a carbazole, a benzofuran, a dibenzofuran, a thianaphthene, a dibenzothiophene, an indazolebenzimidazole, an anthranyl, a benzisoxazole, a benzoxazole, a benzothiazole, a purine, a pyridine, a pyridazine, a pyrimidine, a pyrazine, a triazine, a quinoline, an acridine, an isoquinoline, a phthalazine, a quinazoline, a quinoxaline, a naphthyridine, a phenanthroline, a pteridine, a morpholine, a piperidine and the like.

Moreover, hydrocarbon groups contained in the aliphatic hydrocarbon group, the aryl group and the heterocyclic group may be substituted with at least one optional substituents. The substituent may be a monovalent non-metal atomic group except a hydrogen such as a halogen atom (—F, —Br, —Cl, —I), a hydroxyl group, an alkoxy group, an aryloxy group, a mercapto group, an alkylthio group, an arylthio group, an alkyldithio group, an aryldithio group, an amino group, an N-alkylamino group, a N,N-dialkylamino group, an N-arylamino group, a N,N-diarylamino group, an N-alkyl-N-arylamino group, an acyloxy group, a carbamoyloxy group, an N-alkylcarbamoyloxy group, an N-arylcarbamoyloxy group, a N,N-dialkylcarbamoyloxy group, a N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, an ureido group, an N′-alkylureido group, a N′,N′-dialkylureido group, an N′-arylureido group, a N′,N′-diarylureido group, an N′-alkyl-N′-arylureido group, an N-alkylureido group, an N-arylureido group, an N′-alkyl-N-alkylureido group, an N′-alkyl-N-arylureido group, a N′,N′-dialkyl-N-alkylureido group, a N′,N′-dialkyl-N-arylureido group, an N′-aryl-N-alkylureido group, an N′-aryl-N-arylureido group, a N′,N′-diaryl-N-alkylureido group, a N′,N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group and a carboxyl group, and a conjugated base group thereof; an alkoxycarbonyl group, an aryloxycarbonyl group, a carbamoyl group, an N-alkylcarbamoyl group, a N,N-dialkylcarbamoyl group, an N-arylcarbamoyl group, a N,N-diarylcarbamoyl group, an N-alkyl-N-arylcarbamoyl group, an alkylsulfinyl group, an arylsulfinyl group, an alkylsulfonyl group, an arylsulfonyl group and a sulfo group (—SO₃H), and a conjugated base group thereof; an alkoxysulfonyl group, an aryloxysulfonyl group, a sulfinamoyl group, an N-alkylsulfinamoyl group, a N,N-dialkylsulfinamoyl group, an N-arylsulfinamoyl group, a N,N-diarylsulfinamoyl group, an N-alkyl-N-arylsulfinamoyl group, a sulfamoyl group, an N-alkylsulfamoyl group, a N,N-dialkylsulfamoyl group, an N-arylsulfamoyl group, a N,N-diarylsulfamoyl group, an N-alkyl-N-arylsulfamoyl group and an N-acylsulfamoyl group, and a conjugated base group thereof; an N-alkylsulfonylsulfamoyl group (—SO₂NHSO₂ (alkyl)) and a conjugated base group thereof; an N-arylsulfonylsulfamoyl group (—SO₂NHSO₂ (aryl)) and a conjugated base group thereof; an N-alkylsulfonylcarbamoyl group (—CONHSO₂ (alkyl)) and a conjugated base group thereof; an N-arylsulfonylcarbamoyl group (—CONHSO₂ (aryl)) and a conjugated base group thereof; an alkoxysilyl group (—Si (Oalkyl)₃), an aryloxysilyl group (—Si(Oaryl)₃) and a hydroxysilyl group (—Si(OH)₃), and a conjugated base group thereof; a phosphono group (—PO₃H₂) and a conjugated base group thereof; a dialkylphosphono group (—PO₃(alkyl)₂), a diarylphosphono group (—PO₃(aryl)₂), an alkylarylphosphono group (—PO₃(alkyl)(aryl)) and a monoalkylphosphono group (—PO₃H(alkyl)), and a conjugated base group thereof; a monoarylphosphono group (—PO₃H(aryl)) and a conjugated base group thereof; a phosphonooxy group (—OPO₃H₂) and a conjugated base group thereof; a dialkylphosphonooxy group (—OPO₃ (alkyl)₂), a diarylphosphonooxy group (—OPO₃ (aryl)₂), an alkylarylphosphonooxy group (—OPO₃(alkyl)(aryl)) and a monoalkylphosphonooxy group (—OPO₃H(alkyl)), and a conjugated base group thereof; a monoarylphosphonooxy group (—OPO₃H(aryl)) and a conjugated base group thereof; a cyano group, a nitro group, an aryl group, an alkenyl group, and an alkynyl group. Further, if possible, each of these substituents may be bonded to other substituent or a hydrocarbon where the substituent is substituted to form a ring.

R³ of Formula (I) is preferably a substituted or unsubstituted aryl group having 6 to 40 carbon atoms, more preferably a phenyl group having a substituent including at least one aryl group or hetero cyclic group, and most preferably a phenyl group which is substituted with a substituent having preferably 2 to 4 phenyl groups at 4-position.

Further, it is preferred that the boronic acid compound represented by Formula (I) is substituted with a cross-linkable group because adherence between the support and the optically anisotropic layer may be improved. It is preferred to include a cross-linkable group in R³. The cross-linkable group is generally a polymerizable group such as a vinyl group, an acrylate group, a methacrylate group, an acrylamide group, a styryl group, a vinylketone group, a butadien group, a vinylether group, an oxiranyl group, an aziridinyl group, an oxetane group and the like, preferably a vinyl group, an acrylate group, a methacrylate group, a styryl group, an oxiranyl group or an oxetane group, and most preferably a vinyl group, an acrylate group, an acrylamide group or a styryl group.

Specific examples of the compound represented by Formula (I) are as follows, but the compound used in the present invention is not limited thereto.

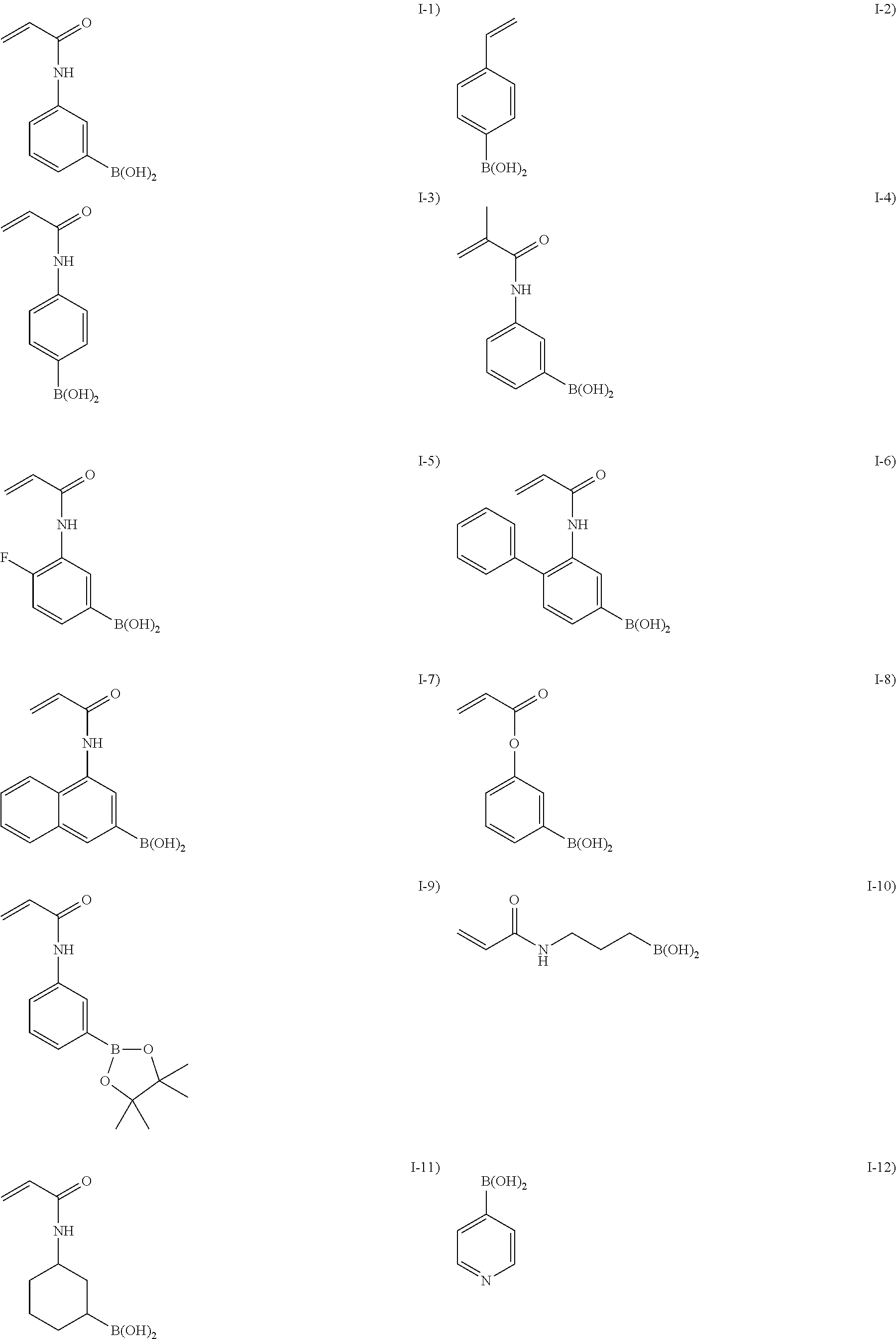

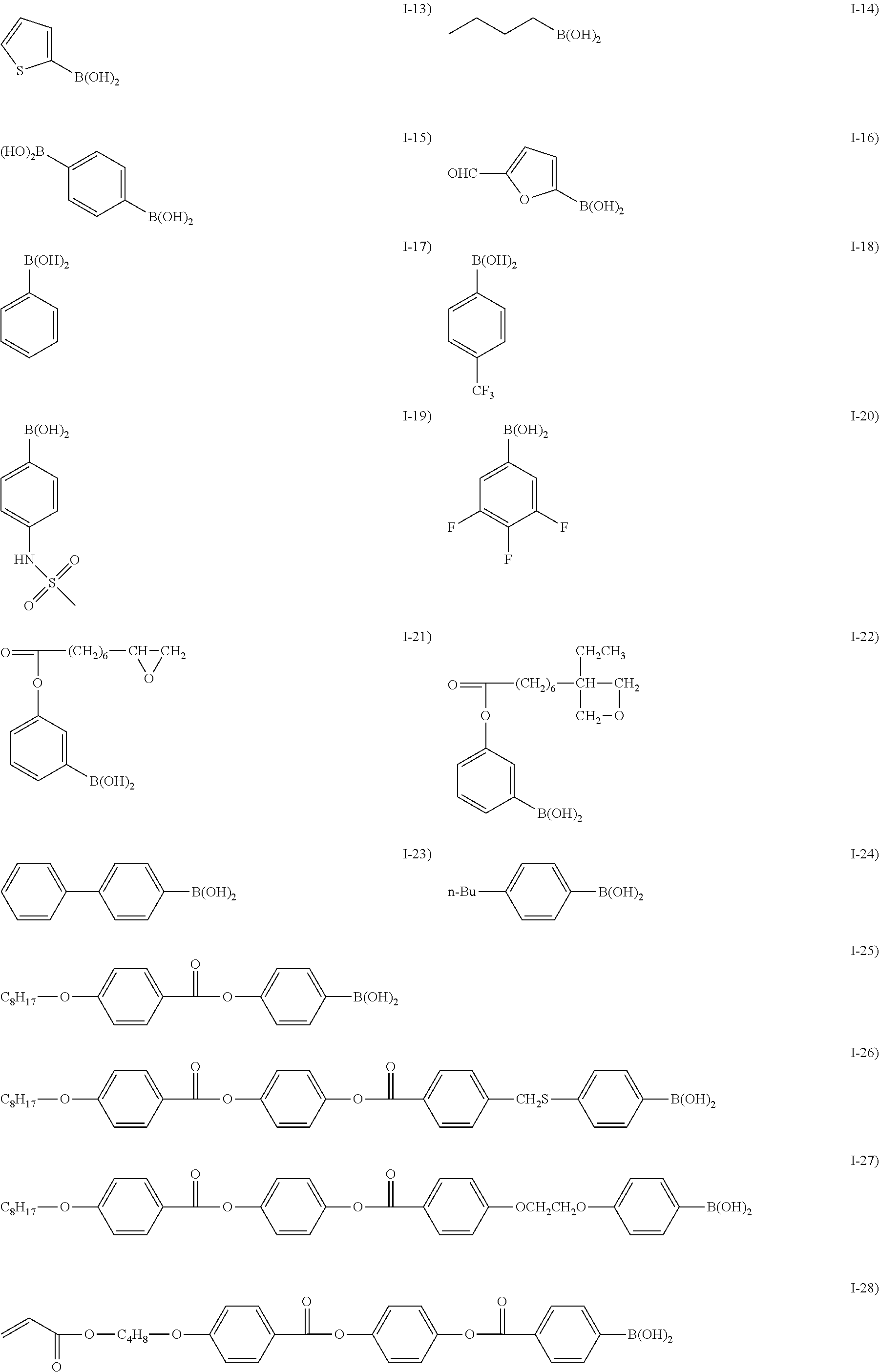

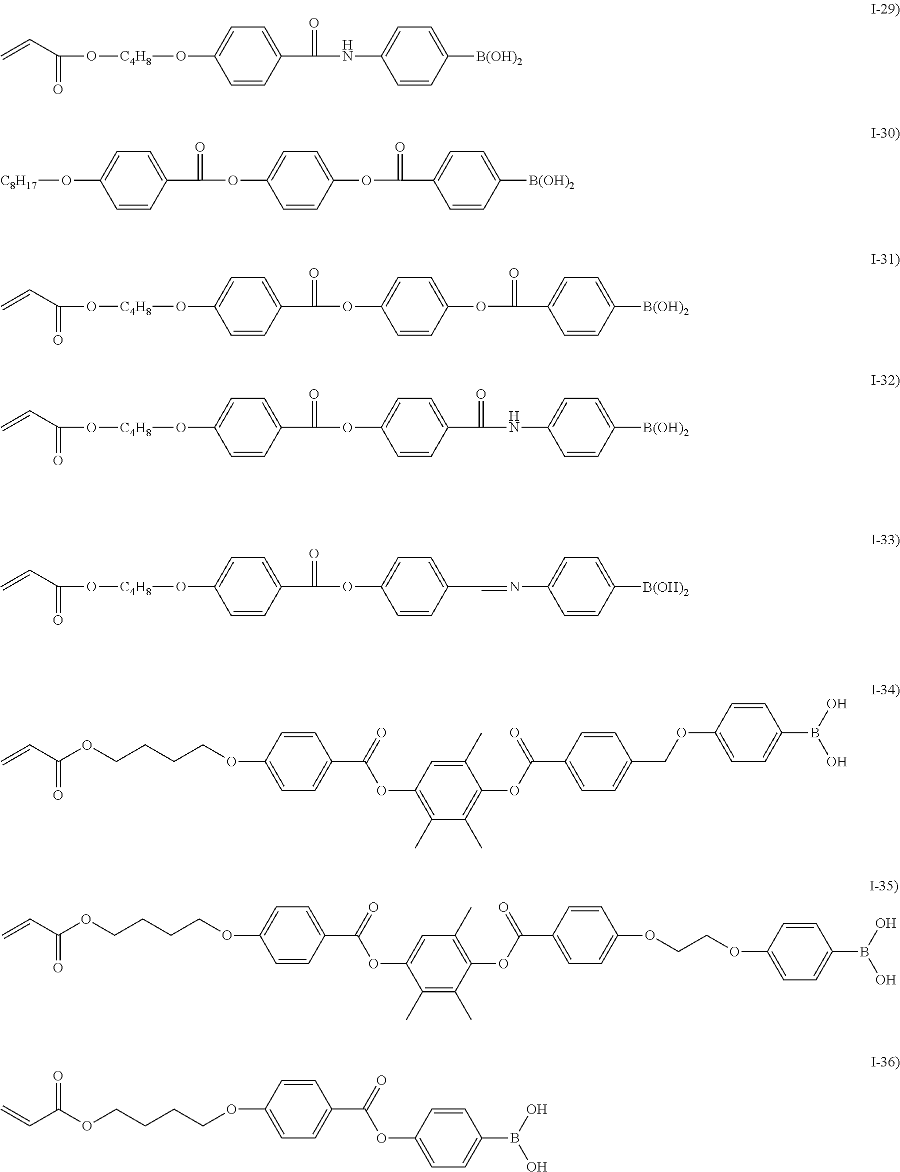

The boronic acid compound may be commercially available, or can be synthesized easily using a boronic acid compound having a substituent as a starting material by conducting a general synthetic reaction such as esterification, amidation and alkylation. Further, if not using the commercially available boronic acid compound, for example, the compound can be synthesized from a halide (for example, arylbromide and the like) with a n-butyllithium and a trialkoxyborane (for example, trimethoxyborane and the like), or synthesized by conducting Wittig reaction using a metallic magnesium.

The preferred range of the content of the boronic acid compound in the optically anisotropic layer is preferably 0.005% by mass to 8% by mass in the optically anisotropic layer in the total solids except solvent in the composition before forming the layer), more preferably 0.01% by mass to 5% by mass, and most preferably 0.05% by mass to 1% by mass.

<Copolymer Containing Repeating Unit Having Fluoroaliphatic Group>

The liquid crystal composition forming the optically anisotropic layer of the optically-compensatory sheet of the present invention may include a copolymer containing a repeating unit having a fluoroaliphatic group. Generally, the copolymer is added for the purpose of controlling the alignment on the air interface of the discotic liquid crystalline compound, and acts on reducing a tilt angle near the air interface of the discotic liquid crystalline compound molecule.

The copolymer containing a repeating unit having a fluoroaliphatic group may be copolymers containing constitutional units derived from fluoroaliphatic group containing monomers as described in the paragraphs [0051] to [0052] of Japanese Patent Laid-Open No. 2008-257205 and constitutional units derived from monomers as described in the paragraphs [0055] to [0056] thereof (preferable example in the paragraph [0054]), and compounds as described in Japanese Patent Laid-Open Nos. 2008-257205, 2008-111110, 2007-272185 and 2007-217656.

The amount of the added compound containing the copolymer containing the repeating unit having a fluoroaliphatic group is preferably 0.2 parts by mass to 2.0 parts by mass, and more preferably 0.3 parts by mass to 1.0 part by mass based on 100 parts by mass of the liquid crystalline compound.

If the amount of the added copolymer containing the repeating unit having a fluoroaliphatic group is less than 0.2 parts by mass, there may be an undesirable case from the viewpoint of the manufacturing feasibility due to large variation of the tilt angle to the mature temperature, and there may be also a case where the plane shape becomes worse due to non-uniform wind during drying. If the amount thereof excesses 2.0 parts by mass, there may be a case where the alignment failure may be easily caused in the liquid crystalline compound.

The composition may be prepared as a coating liquid. The solvent, which can be used for preparing the coating liquid, may preferably be an organic solvent. Examples of the organic solvent includes amide (for example, N,N-dimethylformamide), sulfoxide (for example, dimethylsulfoxide), heterocyclic compound (for example, pyridine), hydrocarbon (for example, benzene, hexane), alkylhalide (for example, chloroform, dichloromethane, tetrachloroethane), ester (for example, methyl acetate, butyl acetate), ketone (for example, acetone, methylethylketone) and ether (for example, tetrahydrofuran, 1,2-dimethoxyethane), and preferably an alkylhalide and a ketone. The organic solvent can be used either alone or in combination of two of them. The coating liquid having the surface tension of 25 mN/m or less (more preferably, 22 mN/m or less) is preferred because the coating liquid can form the optically anisotropic layer having higher uniformity.

Further, the composition is preferably curable, and in this exemplary embodiment, it is preferred to contain a polymerization initiator. The polymerization initiator may be a thermal polymerization initiator or a photopolymerization initiator, but the photopolymerization initiator may be preferred from the viewpoint of easy control. Examples of the photo polymerization initiator generating radicals by the action of light include preferably α-carbonyl compounds (U.S. Pat. Nos. 2,367,661 and 2,367,670), acyloin ethers (U.S. Pat. No. 2,448,828), α-hydrocarbon-substituted aromatic acyloin compounds (U.S. Pat. No. 2,722,512), polynuclear quinone compounds (U.S. Pat. Nos. 3,046,127 and 2,951,758), combinations of triarylimidazole dimers and p-aminophenylketones (U.S. Pat. No. 3,549,367), acridine and phenazine compounds (Japanese Patent Application Laid-Open No. 60-105667, and U.S. Pat. No. 4,239,850), oxadiazole compounds (U.S. Pat. No. 4,212,970), acetophenone-based compounds, benzoin ether-based compounds, benzyl-based compounds, benzophenone-based compounds, thioxanthone-based compounds and the like.

Further, for the purpose of enhancing the sensitivity, a sensitizer may be used in addition to the polymerization initiator. Examples of the sensitizer include n-butylamine, triethylamine, tri-n-butylphosphine, thioxanthone and the like. The photo-polymerization initiator may be used in combination with other photo-polymerization initiator(s). An amount of the photo-polymerization used may be preferably 0.01% by mass to 20% by mass, and more preferably 0.5% by mass to 5% by mass, based on the solids of the coating liquid. For carrying out the polymerization of the liquid crystalline compound, an irradiation with ultraviolet light is preferred.

The composition may contain a non-liquid crystalline polymerizable monomer in addition to the polymerizable liquid crystalline compound. The polymerizable monomer may be preferably a compound having a vinyl group, a vinyloxy group, an acryloyl group or a methacryloyl group. Meanwhile, it is preferred to use a multi-functional monomer having two or more polymerizable functional groups, for example, ethylene oxide modified trimethylolpropane acrylate because the durability is improved. Since the non-liquid crystalline polymerizable monomer is a non-liquid crystalline component, the amount of the component added is not more than 15% by mass, and preferably 0% by mass to 10% by mass based on the liquid crystalline compound.

<Formation of Optically Anisotropic Layer>

One example of the method for forming the optically anisotropic layer is as follows.

A composition prepared as a coating liquid at least containing the discotic liquid crystalline compound and the boronic acid compound represented by Formula (I) is coated to the rubbing treated surface of the alignment film. The coating method may be any known coating method such as a curtain coating method, a dip coating method, a spin coating method, a printing coating method, a spray coating method, a slot coating method, a roll coating method, a slide coating method, a blade coating method, a gravure coating method and a wire bar coating method.

The film coated with the coating film is dried to obtain a desired alignment state of the molecules of the liquid crystalline compound. At this time, the film may preferably be heated. Particularly, if the film is heated at 50° C. to 120° C., for example, the molecules of the discotic liquid crystalline compound may be expressed in the reverse hybrid alignment state and in a state where the direction of the slow axis is orthogonal with respect to the rubbing direction. Therefore, the alignment state can be stably formed. When the film is heated at a temperature lower than 50° C., the alignment disorder becomes large. Meanwhile, when the film is heated at a temperature higher than 120° C., the reverse hybrid alignment may be obtained, but an alignment state of the slow axis tends to be expressed in parallel with respect to the rubbing direction. It is more preferred to heat at a temperature range of 70° C. to 100° C. The heating time is preferably 60 sec to 300 sec, and more preferably 90 to 300 sec.

The optically anisotropic layer is formed by aligning the molecules of the liquid crystalline compound to a desired alignment state, curing by polymerization and then fixing the alignment state. The irradiated light may be X-ray, electron ray, ultraviolet light, visible ray or infrared (heat ray). Among them, ultraviolet light is preferred. As the light source, a low pressure mercury lamp (a sterilization lamp, a fluorescent chemical lamp and a black light), a high pressure discharge lamp (a high pressure mercury lamp and a metal halide lamp) or a short arc discharge lamp (an ultra high pressure mercury lamp, a xenon lamp and a mercury xenon lamp) is preferably used. The irradiation amount thereof is preferably about 50 mJ/cm² to 6,000 mJ/cm², and more preferably about 100 mJ/cm² to 2,000 mJ/cm². In order to control alignment in a short time, the irradiation may preferably be conducted while heating. The heating temperature is preferably about 40° C. to 140° C.

The thickness of the optically anisotropic layer thus formed is not particularly limited, but preferably 0.1 μm to 10 μm, and more preferably 0.5 μm to 5 μm.

<Alignment Film>

In the present invention, materials for the alignment film are not particularly limited. The materials may be selected from known materials for the horizontal alignment film as well as known materials for the vertical alignment film. The alignment film made up of modified or unmodified polyvinyl alcohols may be preferably used. The modified or unmodified polyvinyl alcohols has been also used as the horizontal alignment film, but by adding an onium compound to the composition for forming the optically anisotropic layer, the liquid crystal molecule may be aligned as the tilted alignment state having high average tilt angle or vertical alignment state at the alignment film interface by the interaction between the onium compound and the alignment film, the interaction between the onium compound and the liquid crystalline compound, and the like. Among the modified polyvinyl alcohols, the alignment film containing the polyvinyl alcohols having a unit of the polymerizable group may be preferably used, because the adherence with the optically anisotropic layer is more improved. The preferable polyvinyl alcohols may be the polyvinyl alcohols having at least one hydroxyl group substituted with a group having a oxiranyl moiety or an aziridinyl moiety, for example, modified polyvinyl alcohols as described in the paragraphs [0071] to [0095] of Japanese Patent No. 3,907,735.

The alignment film, which can be used in the present invention, has a face subjected to a rubbing treatment. In the present invention, any common rubbing treatment method may be used. For example, the rubbing treatment may be carried out by rubbing the surface of the alignment film with a rubbing roll. In one embodiment forming the alignment films continuously on the support made from long-type polymer film, the rubbing direction is preferably the same as the longitudinal direction of the polymer film from the viewpoint of the manufacturing feasibility.

<Transparent Support>

For the transparent support, there is no particular limit. One example of the polymer film is a transparent polymer film having low optical anisotropy, but not limited thereto. Herein, the term transparent means that light transmittance of the support is 80% or more. The term low optical anisotropy specifically means that the in-plane retardation (Re) is 20 nm or less, and more preferably 10 nm or less. The transparent support may be a long film in a form of roll, or a sheet of the final product size, for example, a rectangle sheet. It is preferred that the alignment film and the optically anisotropic layer are continuously formed using the rolled long-type polymer film as the support followed by cutting the film to a desired size.

The polymer film, which can be used as the support, may be a cellulose acylate film, a polycarbonate film, a polysulfone film, a polyethersulfone film, a polyacrylate and polymethacrylate film, a cyclic polyolefin film and the like, preferably a cellulose acylate film, and more preferably a cellulose acetate film. In a case where a cellulose acylate film is used, a decline of in-plane contrast can be further inhibited.

Thickness of the polymer film used as a support is not particularly limited, but generally, the thickness is preferably 20 μm to 500 μm, and more preferably 30 μm to 200 p.m.

The polymer film for a support may be any film fabricated by any method of a solution film-forming method and a melting film-forming method. For a cellulose acylate film, a film fabricated by a solvent cast method is preferred. Further, for the polymer film used as a transparent support, surface treatment (for example, glow discharge treatment, corona discharge treatment, ultraviolet (UV) treatment, flame treatment, saponification treatment) may be conducted in order to improve adhesion to the alignment film formed thereon. An adhesive layer (undercoated layer) can be arranged on the transparent support.

(Contrast Value)

Film contrast value represent by the following Equation (1) of the optically-compensatory sheet of the present invention is preferably more than 4,000, more preferably more than 6,000, and most preferably more than 8,000.

Film contrast value=(Maximum luminance of an optically-compensatory sheet arranged on two polarizing plates of parallel nicols state)/(Minimum luminance of an optically-compensatory sheet arranged on two polarizing plates of cross nicols state) Equation (1)

(Adherence)

The optically-compensatory sheet of the present invention preferably has one point or more (out of 10 points) in the crosscut adhesion test (JIS K5400-8.5 (JIS D0202)), more preferably 5 points or more, and most preferably 10 points or more.

<<Polarizing Plate>>

The present invention also relates to a polarizing plate at least having a polarization film and the optically-compensatory sheet of the present invention. An exemplary embodiment of the polarizing plate of the present invention is a polarizing plate in which the optically-compensatory sheet of the present invention is laminated on one surface of a polarization film, and a protective film is laminated on the other surface. In this exemplary embodiment, the other side of the support of the optically-compensatory sheet of the present invention (the face of the side where the alignment film and the optically anisotropic layer are not formed) is preferably adhered to one surface of the polarization film. The protective film adhered to the other surface is not particularly limited, and the film may be preferably selected from examples of the polymer film, which can be used as the support. A preferred example of the protective film is a cellulose acylate film such as a triacetyl cellulose film.

The polarization film includes an iodine-based polarization film, a dye-based polarization film using a dichroic dye or polyene-based polarization films, and any of them may be used in the present invention. The iodine-based polarization film and the dye-based polarization film are generally fabricated by using polyvinyl alcohol-based films.

The polarizing plate may be fabricated by continuously adhering the long-type polarization film and the long-type optically-compensatory sheet of the present invention. In fabricating the optical film, it is preferred that the rubbing treatment is conducted along the longitudinal direction of the support from the viewpoint of the manufacturing feasibility, as described above. In the optical film of the present invention, the slow axis of the optically anisotropic layer is orthogonal to the rubbing direction, namely orthogonal to the longitudinal direction. Accordingly, the optical film of the present invention may be laminated by matching the longitudinal direction when adhering to the long-type polarization film. As a result, a polarizing plate in which the slow axis of the optically anisotropic layer and the absorption axis of the polarization film are orthogonal to each other can readily be manufactured sequentially.

<<Liquid Crystal Display Device>>

The present invention also relates to a liquid crystal display device including the optically-compensatory sheet or the polarizing plate of the present invention. The optical film of the present invention is particularly suitable for optical-compensation of a TN-type liquid crystal display device. Thus, a preferred embodiment of the liquid crystal display device of the present invention is the TN-type liquid crystal display device. A TN-mode liquid crystal cell and the TN-type liquid crystal display device have been well known. Δn·d of the liquid crystal cell is about 300 nm to 500 nm. The polarizing plate of the present invention is preferably disposed as facing the optical film of the present invention to the liquid crystal cell side. If there is macro disorder in the optically anisotropic layer used for the optically-compensation, for example, it would be one cause of the in-plane contrast deterioration of the liquid crystal display device. The optically anisotropic layer contained in the optically-compensatory sheet of the present invention, which is formed by fixing the reverse hybrid alignment of the discotic liquid crystal molecules, shows very low macro disorder of the arrangement as compared with the layer formed by fixing the forward hybrid alignment. Thus, according to the present invention, sufficient optical-compensation can be obtained by the optically-compensatory sheet of the present invention, without deteriorating the in-plane contrast of the liquid crystal display device.

### EXAMPLES

Hereinafter, the present invention will be described in more detail with reference to Examples. The materials, amounts and ratios, operations, and treatment order and the like described in Examples below may be appropriately modified without departing from the intent of the present invention. Therefore, the scope of the present invention is not limited to the specific examples as described below.

### Example 1

### Fabrication of Optically-Compensatory Sheet

(Fabrication of Support)

The following composition was put into a mixing tank, and followed by stirring while heating to 30° C. to dissolve the individual components, to prepare a cellulose acetate solution (dope) for an inner layer and an outer layer.

TABLE 1

| Composition of cellulose acetate | Inner | Outer |
|---|---|---|
| solution (parts by mass) | layer | layer |
| Cellulose acetate, degree of | 100 | 100 |
| acetylation = 60.9% | | |
| Triphenyl phosphate (plasticizer) | 7.8 | 7.8 |
| Biphenyl diphenyl phosphate (plasticizer) | 3.9 | 3.9 |
| Methylene chloride (first solvent) | 293 | 314 |
| Methanol (second solvent) | 71 | 76 |
| 1-Butanol (third solvent) | 1.5 | 1.6 |
| Silica particle (AEROSIL R972, | 0 | 0.8 |
| Manufactured by NIPPON AEROSIL CO., LTD.) | | |
| The following retardation enhancer | 1.7 | 0 |

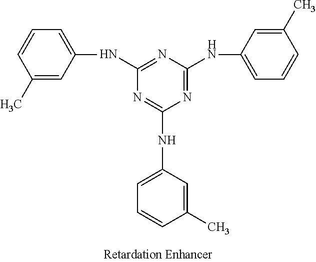 [SMILES: Cc1cccc(Nc2nc(Nc3cccc(C)c3)nc(Nc3cccc(C)c3)n2)c1]

The obtained inner layer dope and the outer layer dope were cast using a three-layer co-casting die onto a drum cooled at 0° C. The film containing residual solvent in an amount of 70% by mass was peeled off from the drum, fixed to a pin tenter on both edges thereof, dried at 80° C. while being conveyed at a draw ratio in the conveying direction of 110%, and further dried at 110° C. after a residual solvent amount of 10% was reached. Then, the film was further dried at 140° C. for 30 min to obtain a cellulose acetate film containing a residual solvent in an amount of 0.3% by mass (outer layer: 3 μm, inner layer: 74 μm, outer layer: 3 μm). The obtained cellulose acetate film was found to have a width of 1,340 mm and a thickness of 80 μm.

(Fabrication of Alignment Film)

Saponification treatment was conducted on the support fabricated above, and then an alignment film coating liquid of the following composition was coated thereon using a #16 wire bar coater in an amount of 28 mL/m². The obtained film was dried for 60 sec under a hot air of 60° C., further dried for 150 sec under a hot air of 90° C. to form the alignment film of 1.1 μm thick.

TABLE 2
(Composition of Coating Liquid for Alignment Film)

| Component | |
|---|---|
| Modified polyvinyl alcohol of following Formula (*) | 10 parts by mass |
| Water | 371 parts by mass |
| Methanol | 119 parts by mass |
| Glutaraldehyde (Crosslinking agent) | 0.5 parts by mass |
| Citric acid ester (Manufactured by | 0.35 parts by mass |
| SANKYO CHEMICAL CO., LTD., AS-3) | |

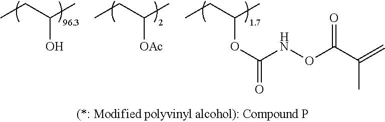

(Aligning Treatment)

Rubbing treatment was conducted on the surface on which the alignment film was formed so as to adjust the alignment in the direction parallel to the conveying direction of the alignment film-coated support. A rubbing roll was rotated at 450 rpm.

(Coating Formation of Optically Anisotropic Layer)

The composition below was dissolved in methylethyl ketone of 270 parts by mass to prepare a coating liquid.

(Composition for Fabricating Optically Anisotropic Layer)

| | |
|---|---|
| Following liquid crystalline compound (1) | 80.0 parts by mass |
| Following liquid crystalline compound (1) | 20.0 parts by mass |
| Following fluoroaliphatic group-containing polymer (1) | 0.6 parts by mass |
| Following fluoroaliphatic group-containing polymer (2) | 0.2 parts by mass |
| Photo-polymerization initiator (IRGACURE 907, Ciba-Geigy Corp.) | 3.0 parts by mass |
| Sensitizing agent (KAYACURE DETX, Manufactured by NIPPON KAYAKU CO., LTD.) | 1.0 part by mass |
| Following low-tilt angle controlling agent | 0.25 parts by mass |
| Following high-tilt angle controlling agent | 1.0 part by mass |

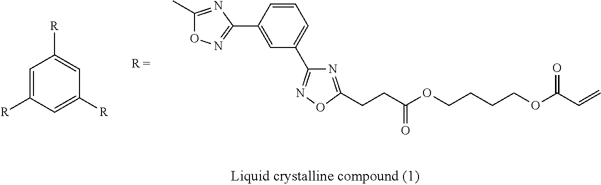

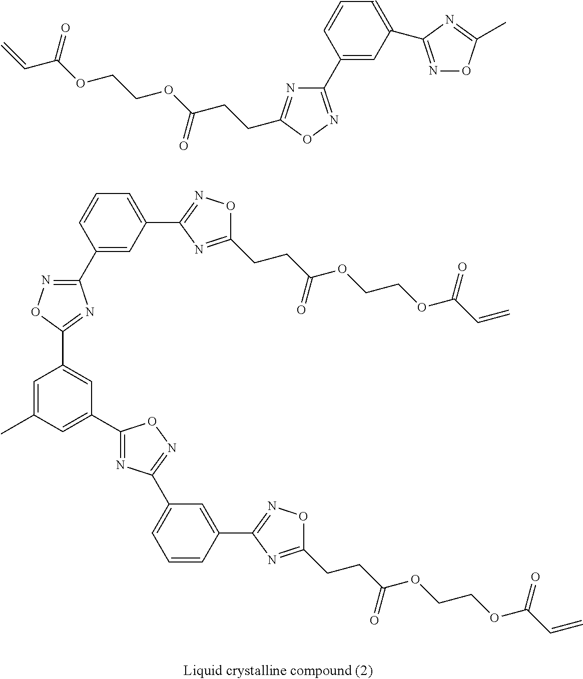

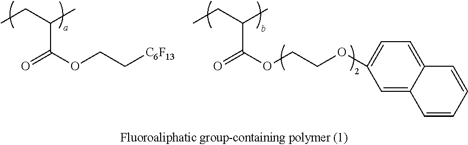

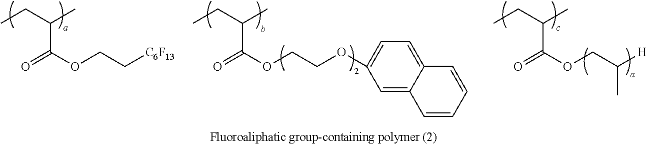

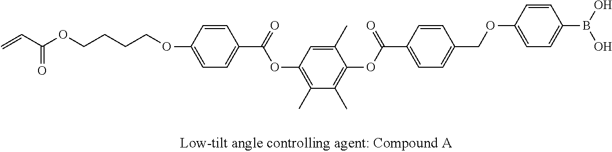 [SMILES: C=CC(=O)OCCCCOc1ccc(C(=O)Oc2cc(C)c(OC(=O)c3ccc(COc4ccc(B(O)O)cc4)cc3)c(C)c2C)cc1]

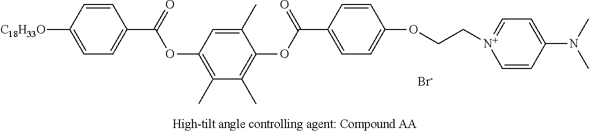

The prepared coating liquid was coated on the alignment film using a #2.8 wire bar in an amount of 4.8 mL/m², followed by heating it in a 120° C. water bath for 300 sec to align discotic liquid crystalline compounds. Then, cross-linking reaction was conducted by irradiating ultraviolet light for 1 min using a 160 W/cm high pressure mercury lamp at 80° C., the discotic liquid crystalline compounds were polymerized and fixed to form an optically anisotropic layer, and thereby fabricating the optically-compensatory sheet of Example 1. Thickness of the optically anisotropic layer was 0.8 μm, liquid crystal director angle of the support side was 0° and the liquid crystal director angle of the air interface side was 75°.

Film contrast was 10,000, and the film showed no alignment failure and good adherence. The film contrast, the alignment failure and the adherence were measured and evaluated as follows. Meanwhile, the liquid crystalline compound of the optically anisotropic layer showed reverse-hybrid alignment.

(Film Contrast)

The maximum luminance and the minimum luminance of the optically-compensatory sheet intercalated between two polarizing plates were measured by using a light luminance measuring device (manufactured by TOPCON CORPORATION, BM5), and film contrast value was determined by the following Equation (1).

Film contrast value=(Maximum luminance of an optically-compensatory sheet arranged on two polarizing plates of parallel nicols state)/(Minimum luminance of an optically-compensatory sheet arranged on two polarizing plates of cross nicols state) Equation (1)

(Alignment Failure)

Alignment failure of the liquid crystalline compounds in the optically anisotropic layer was determined by observing it using a polarization microscope with a magnifying power of 40.

A: No alignment failure

B: 3 or more alignment failures

(Adherence)

Adherence of the optically anisotropic layer was evaluated by a crosscut adhesion test of JIS K5400-8.5 (JIS D0202).

### Examples 2 to 8 and Comparative Examples 1 to 3

In fabricating the optically-compensatory sheet of Example 1, the optically-compensatory sheet was fabricated in the same manner as in Example 1, except that kinds and amounts of the low-tilt angle controlling agent and the high-tilt angle controlling agent used for the coating liquid for forming the optically anisotropic layer were changed as shown in the following Table 3 and the modified polyvinyl alcohol (Compound p) used of the alignment film coating liquid composition was changed as shown in the following Table 3. The liquid crystal director angle of the support side was as shown in the following Table 3. Further, the film contrast, the alignment failure and the adherence were evaluated in the same manner as in Example 1, and the results are shown in the following Table 3.

TABLE 3

| | Liquid crystal director controlling agent | | | | | | | |
|---|---|---|---|---|---|---|---|---|
| | Low-tilt angle | High-tilt angle | | Director angle of | | Alignment | | |
| | controlling agent | controlling agent | Alignment film | support side | Film contrast | failure | Adherence | |
| Example 1 | Compound A | Compound AA | Compound P | 0° | 10,000 | A | 10 | points |
| | 0.25 parts by mass | 1.0 part by mass | | | | | | |
| Comparative. | — | — | Compound P | 80° | 3,000 | A | 10 | points |
| Example 1 | | | | | | | | |
| Comparative. | Compound X | Compound AA | Compound P | 0° | 10,000 | A | 0 | point |
| Example 2 | 0.25 parts by mass | 1.0 part by mass | | | | | | |
| Comparative. | Compound Y | Compound AA | Compound P | 0° | 10,000 | B | 10 | points |
| Example 3 | 0.25 parts by mass | 1.0 part by mass | | | | | | |
| Example 2 | Compound A | Compound AA | Compound Q | 0° | 10,000 | A | 8 | points |
| | 0.25 parts by mass | 1.0 part by mass | | | | | | |
| Example 3 | Compound A | Compound AA | Compound R | 0° | 8,000 | A | 5 | points |
| | 0.25 parts by mass | 1.0 part by mass | | | | | | |
| Example 4 | Compound A | Compound AA | Compound P | 20° | 8,000 | A | 10 | points |
| | 0.25 parts by mass | 1.2 parts by mass | | | | | | |
| Example 5 | Compound A | Compound AA | Compound P | 30° | 6,000 | A | 10 | points |
| | 0.25 parts by mass | 1.4 parts by mass | | | | | | |
| Example 6 | Compound A | Compound AA | Compound P | 40° | 4,000 | A | 10 | points |
| | 0.25 parts by mass | 1.6 parts by mass | | | | | | |
| Example 7 | Compound B | Compound AA | Compound P | 0° | 10,000 | A | 10 | points |
| | 0.25 parts by mass | 1.0 part by mass | | | | | | |
| Example 8 | Compound C | Compound AA | Compound P | 0° | 8,000 | A | 10 | points |

| | |
|---|---|
| 0.25 parts by mass | 1.0 part by mass |

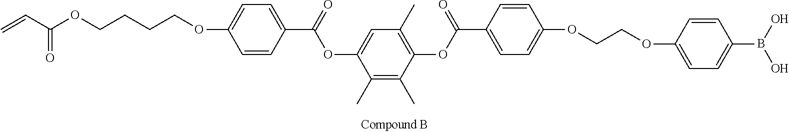 [SMILES: C=CC(=O)OCCCCOc1ccc(C(=O)Oc2cc(C)c(OC(=O)c3ccc(OCCOc4ccc(B(O)O)cc4)cc3)c(C)c2C)cc1]

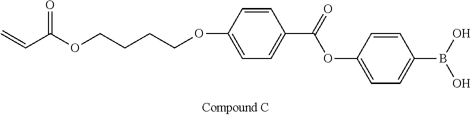 [SMILES: C=CC(=O)OCCCCOc1ccc(C(=O)Oc2ccc(B(O)O)cc2)cc1]

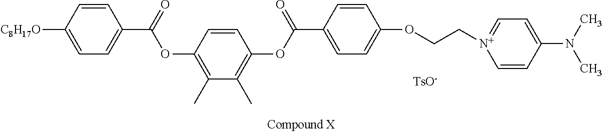

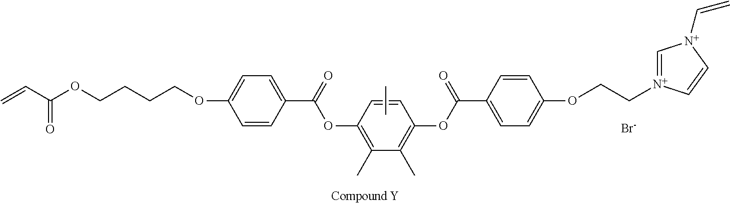

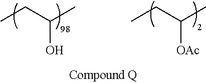

Compound Q

Compound R: polyimide coating liquid (manufactured by Nissan Chemical Industries. Ltd., SE-130)

As shown in Table 3, as compared with Comparative Examples 1 to 3, Examples 1 to 8 showed better film contrast, alignment failure and adherence.

### Comparative Example 4

### Fabrication of Polarizing Plate

A straight polarization film was fabricated by adsorbing iodine to a stretched polyvinyl alcohol film. Then, saponification treatment was conducted on a triacetyl cellulose film (TAC-TD80U, manufactured by Fujifilm Corporation), and the film was adhered to one face of the straight polarization film using a vinyl alcohol-based adhesive. Further, the optically-compensatory sheet fabricated in Comparative Example 1 was adhered to the other face of the straight polarization film using the polyvinyl alcohol-based adhesive such that the surface of the support of the optically-compensatory sheet, in which the optically anisotropic layer was not formed, faces to the surface of the straight polarization film, thereby fabricating a polarizing plate P-1. At this time, the conveying direction of the optically-compensatory sheet was parallel to an absorption axis of the polarizer.

<Fabrication/Evaluation of TN-mode Liquid Crystal Display Device>

A pair of the polarizing plate (upper polarizing plate and lower polarizing plate) installed at a liquid crystal display device (AL2216W, manufactured by Acer Inc.) using a TN-type liquid crystal cell were peeled off, and instead, the fabricated polarizing plates P-1 were adhered to both side of the cell using an adhesive while setting the absorption axis of the polarizer in the same way as the original liquid crystal display device such that the optically-compensatory sheet was arranged at the liquid crystal cell side. The in-plane contrast in the liquid crystal display device was 1,100 (measuring device: BM-5, manufactured by TOPCON).

### Example 9

### Fabrication of Polarizing Plate

A polarizing plate P-2 was fabricated in the same manner as in Comparative Example 5 except that the optically-compensatory sheet fabricated in Example 1 was used.

<Fabrication/Evaluation of TN-MODE Liquid Crystal Display Device>

A TN-mode liquid crystal display device was fabricated in the same manner as in Comparative Example 4 except that the polarizing plate P-2 was used. The in-plane contrast became 1,500, and thus, was obviously improved, as compared with the in-plane contrast of Comparative Example 4. Further, there were no adherence problem and no alignment failure.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An optically-compensatory sheet comprising,
at least one optically anisotropic layer containing a discotic liquid crystalline compound on a transparent support,
wherein the optically anisotropic layer contains a boronic acid compound represented by the following Formula (I): 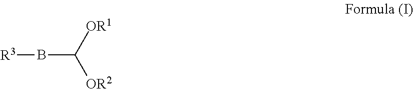
wherein, each of R¹ and R² independently represents a hydrogen atom, a substituted or unsubstituted aliphatic hydrocarbon group, an aryl group or a hetero cyclic group, and R¹ and R² may be linked to each other to form a ring, and
R³ represents a substituted or unsubstituted, a substituted or unsubstituted aliphatic hydrocarbon group, a substituted or unsubstituted aryl group or a substituted or unsubstituted heterocyclic group.

2. The optically-compensatory sheet according to claim 1, further comprising,
an alignment film provided between the transparent support and the optically anisotropic layer,
wherein the alignment film is a polyvinyl alcohol.

3. The optically-compensatory sheet according to claim 1,
wherein a liquid crystal director angle of the discotic liquid crystalline compound at a support side is 0° or more and less than 40°.

4. The optically-compensatory sheet according to claim 1,
wherein a film contrast value represented by the following Equation (1) is 4,000 or more:
Film contrast value=(Maximum luminance of an optically-compensatory sheet arranged on two polarizing plates of parallel nicols state)/(Minimum luminance of an optically-compensatory sheet arranged on two polarizing plates of cross nicols state). Equation (1)

5. The optically-compensatory sheet according to claim 1,
wherein the discotic liquid crystalline compound has an inverse hybrid alignment.

6. The optically-compensatory sheet according to claim 1,
wherein a value from a crosscut adhesion test in accordance with JIS K5400-8.5 (JIS D0202) is 1 point or more.

7. A polarizing plate comprising an optically-compensatory sheet according to claim 1.

8. A liquid crystal display device comprising the optically-compensatory sheet of according to claim 1.

9. A liquid crystal display device comprising the polarizing plate according to claim 7.
